(19) United States
(12) Patent Application Publication
(10) Pub. No.: US 2016/0328309 A1
(43) Pub. Date: Nov. 10, 2016

(54) METHOD AND APPARATUS FOR MONITORING A CONTROL FLOW OF A COMPUTER PROGRAM

(71) Applicant: Robert Bosch GmbH, Stuttgart (DE)

(72) Inventors: Gary Morgan, Thixendale (GB); Heinz Tilsner, Stuttgart (DE); Gary Plumbridge, York (GB)

(21) Appl. No.: 15/143,796

(22) Filed: May 2, 2016

(30) Foreign Application Priority Data
May 8, 2015 (EP) 15166898.5

(51) Int. Cl. G06F 11/36

(52) U.S. Cl. CPC G06F 11/3604

(57) ABSTRACT

Method for monitoring a control flow of an imperative computer program, including annotating scheduling the program with calls to a monitor, each call by a thread indicating the thread, scheduling the program and the monitor for execution by an operating system, and, scheduling upon receiving the call, the monitor verifying the thread by means of the operating system.

### CROSS REFERENCE

The present application claims the benefit under 35 U.S.C. §119 of European Patent Application No. EP15166898.5 filed on May 8, 2015, which is expressly incorporated herein by entirety.

### FIELD

The present invention pertains to a method for monitoring a control flow of an imperative computer program. The present invention further pertains to corresponding apparatus, a corresponding computer program as well as a corresponding storage medium.

### BACKGROUND INFORMATION

In computer science, control flow or flow of control refers to the specification of the order in which the individual statements, instructions, or function calls of an imperative program are executed or evaluated. The emphasis on explicit control flow distinguishes an imperative programming language from a declarative programming language.

Japan Patent No. JP 55739456 A describes an early low-level program device for monitoring the control flow of a program. To this end, when operation of some task has ended, in case of deriving a program bus to reach the program, a trigger command is given to the side of the CPU by pushing a branch trace start key of an operator's panel. As a result, a microprogram control part extracts a program address in order from the present one extending from the highest rank memory area of a stack register to the lowest rank area, and transfers it to a display part of the panel. In this way, a program bus is grasped by tracing the branch back to the past and tracing the branch locus extending from a program address which has ended at present, to a program which has been executed previously.

U.S. Pat. No. 7,168,065 B1 describes a more advanced method for monitoring program flow to verify execution of proper instructions by a processor such as for an embedded anti-lock braking system (ABS). To this end, a sequence of instructions is transmitted to the processor to execute the monitored program. These instructions are analyzed, and the result of the analysis is verified by referring to reference data recorded with the program. The reference data can include a value predetermined in such a way as to correspond to the result of the analysis produced during the monitoring process only if all the instructions have been actually analyzed during the program flow.

Finally, in an attempt to meet the requirements for logical program flow monitoring facilities imposed by AUTOSAR R4.0, Published PCT Application No. WO 2009154498 describes a method for integrity monitoring within a multi-tasking environment comprising: preprocessing source files during compile time; identifying all basic blocks and signing them with signatures during compile time; analyzing language constructions and linking nodes according to syntactically allowable program flow during compile time; transmitting a control graph to a monitoring process or putting it into a shared memory during runtime; posting on each basic block a signature to a signatures stream for each task during runtime and switching among the signatures streams and checking during run time that the signatures make an allowable path.

### SUMMARY

The present invention provides a method for monitoring a control flow of an imperative computer program, corresponding apparatus, a corresponding computer program as well as a corresponding storage medium.

An example embodiment of the present invention may have the advantage that a first class of errors is correctly identified those conventional monitoring subsystems, while being able to perform program flow monitoring in general, will report incorrectly by design.

In an example embodiment, it may be provided that the program comprises basic blocks of execution with predetermined transitions between the blocks; when the program is annotated, a control flow graph is created for each thread, the graph comprising nodes representing the blocks and arcs representing the transitions; the monitor stores the graph; each call from a block further indicates the block; upon receiving at least two subsequent calls, the monitor detects the transition between the blocks; and the monitor matches the transition to an arc. If the monitor detects that the monitored code departs from the digraph then it is assumed that there is an error in the monitored code. Therefore errors in the flow of control of the monitored code can be detected.

According to a further aspect of the present invention, it may be provided that, when the graph is created, a worst-case execution time of a block is assigned to the node representing the block; upon verifying the thread, the monitor times the execution of the thread; and the monitor verifies the execution time. This way, a second class of errors is correctly identified that known monitoring subsystems will be unable to detect.

### BRIEF DESCRIPTION OF THE DRAWINGS

Example embodiments of the present inventions are illustrated in the figures and explained in further detail below.

FIG. 1 shows the flowchart of a method according to a first embodiment.

FIG. 2 shows a control flow graph for a program comprising two threads of execution.

FIG. 3 shows a first error in the program of FIG. 2.

FIG. 4 shows a second error in the program of FIG. 2.

FIG. 5 shows an improved control flow graph.

FIG. 6 schematically shows an electronic control unit according to a second embodiment.

Similar reference characters denote corresponding features consistently throughout the figures.

### DETAILED DESCRIPTION OF EXAMPLE EMBODIMENTS

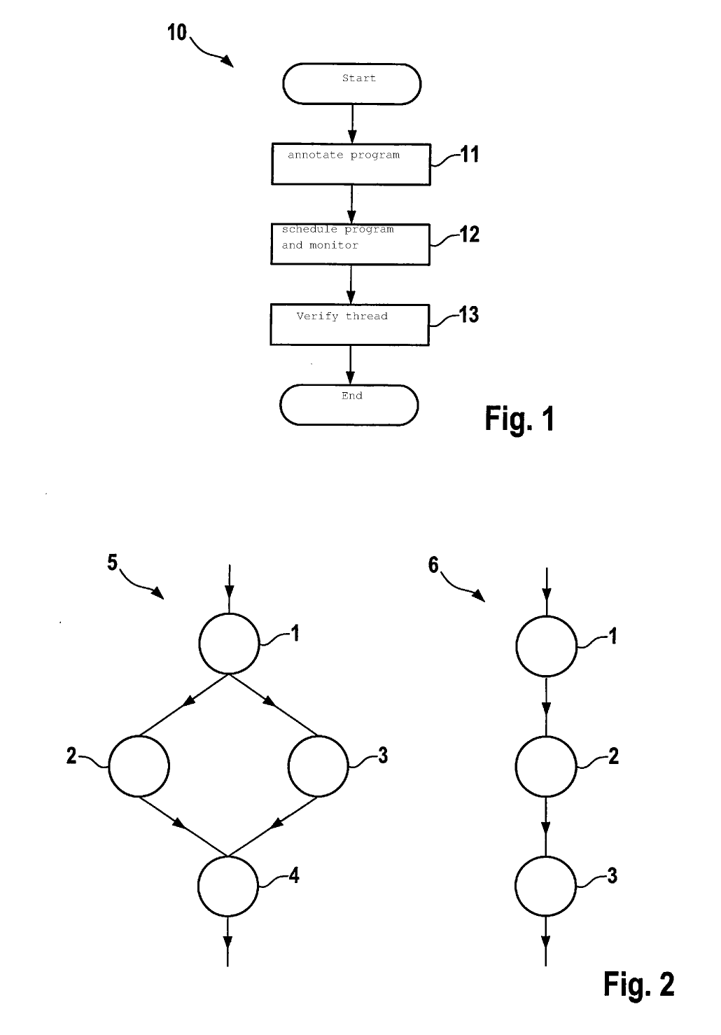

FIG. 1 illustrates a method 10 for monitoring a control flow of an imperative computer program comprising threads of execution. In conformance with the terminology of computer science, by thread of execution is meant the smallest sequence of programmed instructions that can be managed independently by a scheduler, which is typically a part of the operating system (OS). The implementation of threads and processes differs between operating systems, but in most cases a thread is a component of a process, which in turn is an instance of the program being executed. Multiple threads can exist within the same process and share resources such as memory, while different processes do not share these resources. In the following, the term “thread” is used in a broad sense, encompassing interrupt handlers and other tasks as well as traditional threads.

According to the given example embodiment, the program is annotated (11) with calls to a monitor, each call by a thread indicating the thread. The program and the monitor are scheduled for execution 12 by an operating system, and, upon receiving the call, the monitor verifies (13) the thread by means of the operating system.

FIG. 2 shows the method 10 in further detail. To this end, it may be assumed that the program, like any imperative computer program, is composed of basic blocks of execution 12. In computing, by basic block is meant a portion of the code within the program with only one entry point and only one exit point, making that portion highly amenable to analysis. Predetermined transitions between the blocks define the valid flow of control through the program.

When the program is annotated (11), a so-called control flow graph (CFG) is created for each of two threads 5, 6 and stored by the monitor, the graph comprising nodes 1, 2, 3, 4 representing the blocks and arcs representing the transitions. Such control flow graph is commonly used in computer science as a representation, using the notation of a directed graph or digraph, of all paths that might be traversed through the program during its execution 12.

When the monitored code runs, it calls the monitor identifying the current thread 5, 6 and the position reached in the digraph. The monitor compares the sequence of calls with its internally-stored digraph. If the monitor detects that the monitored code departs from the digraph then it is assumed that there is an error in the monitored code. Therefore errors in the flow of control of the program can be detected.

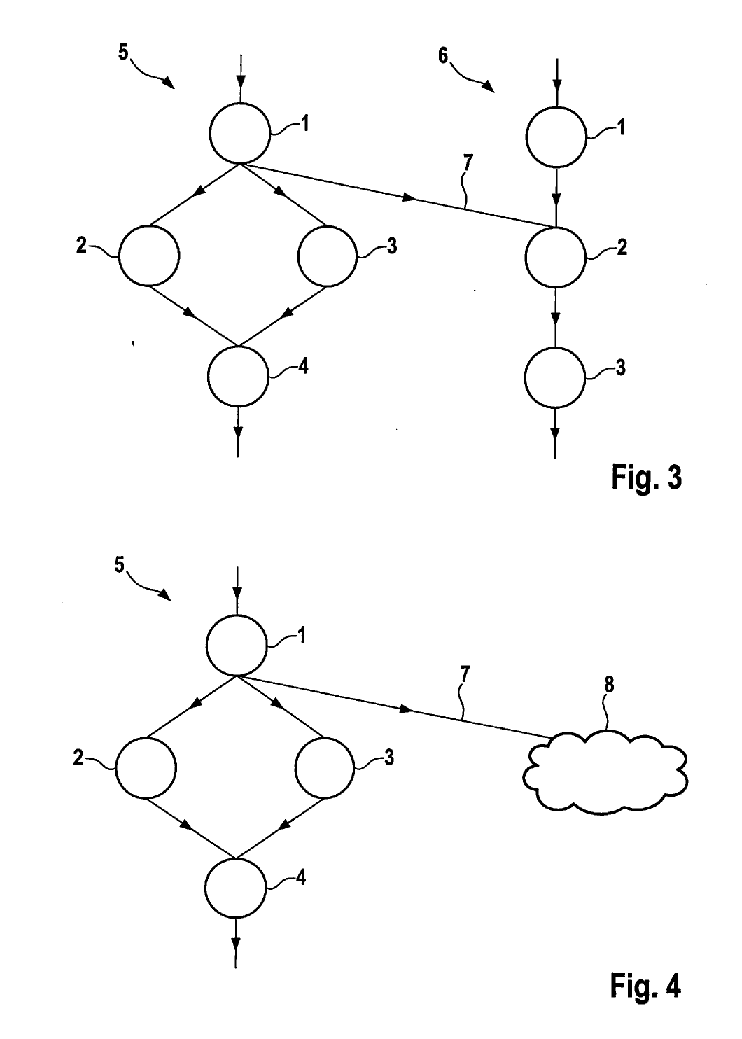

A first such error is best explained referencing FIG. 3, depicting an incorrect transition 7 from node 1 of thread 5 to node 2 of thread 6. When the monitoring code is called, it makes a call to the operating system or task scheduler in order to find out which thread 5, 6 called it. Since the calling thread 6 found via the OS differs from the thread 5 reported in the call to the monitor, the incorrect transition 7 has been discovered. The monitor further knows that the thread in error is the thread 6 reported by the OS and not the thread 5 in the call to the monitor.

FIG. 4 illustrates a second error where there is some code 8 that contains no calls to the monitor, for example, commonly used library code 8. An error in flow control of the monitored code that incorrectly causes the library code 8 to be entered will not at first result in the monitor detecting an error.

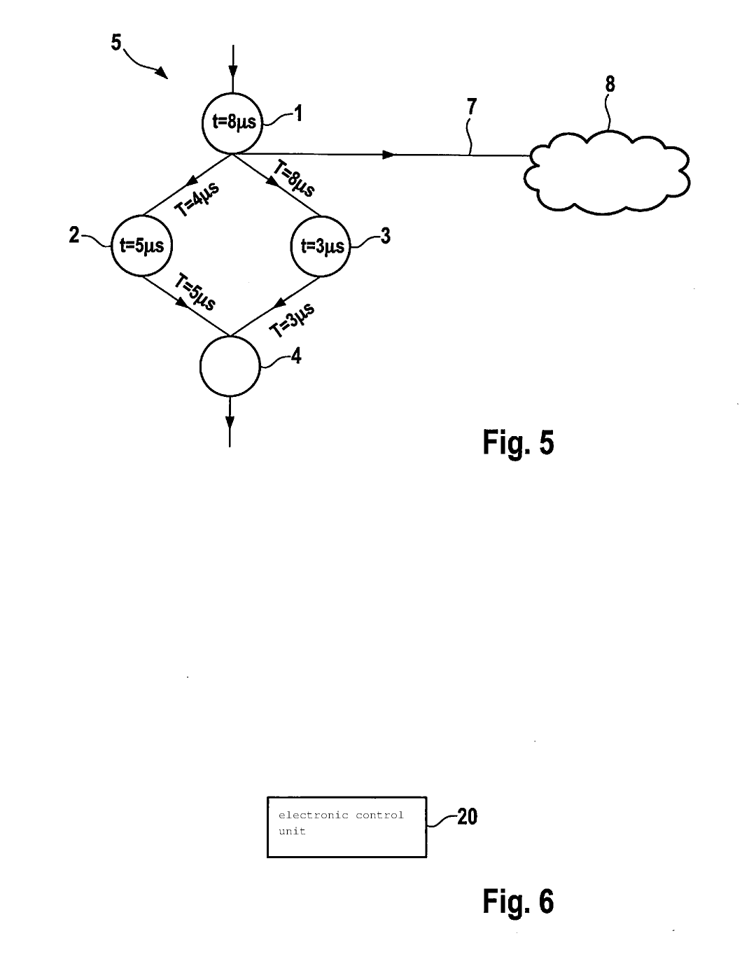

To take account of this class of errors, when the digraph is created, some method—either analysis or measurement—is used to assign a worst-case execution time (WCET) T to each arc in the digraph and the worst WCET t for all arcs leaving a node 1, 2, 3, 4 is assigned to that node 1, 2, 3, 4. This is shown in FIG. 5.

When the monitor is called, two things happen, assuming that the first error has not occurred: First, the monitor knows which arc was taken and therefore knows the WCET T for that arc and can verify that this was not exceeded. Second, a timer is set up, to expire in the future, at a time equal to “now”+the time t stored at the node 1, 2, 3, 4. If the timer expires then it is known that none of the arcs valid at that particular node 1, 2, 3, 4 was taken and that the thread 5, 6 is in error. When OS pre-emptions take place, the timer needs to be stopped and resumed when the thread 5, 6 resumes. This allows the second error to be detected.

This method 10 may be implemented, for example, in software or hardware or a hybrid of software and hardware, for example in an electronic control unit 20 as the schematic diagram of FIG. 6 illustrates.

What is claimed is:

1. A method for monitoring a control flow of an imperative computer program comprising threads of execution, comprising:
annotating the program with calls to a monitor, each call by a thread indicating the thread;
scheduling the program and the monitor for execution by an operating system; and
upon receiving a call, the monitor verifying the thread via the operating system.

2. The method according to claim 1, wherein the program comprises basic blocks of execution with predetermined transitions between the blocks, the method further comprising:
when the program is annotated, creating a control flow graph is created for each thread, the graph including nodes representing the blocks and arcs representing the transitions; and
storing, by the monitor, the graph;
wherein each call from a block further indicates the block, wherein upon receiving at least two subsequent calls, the monitor detects the transition between the blocks, and the monitor matches the transition to an arc.

3. The method according to claim 2, wherein when the graph is created, a worst-case execution time of a block is assigned to the node representing the block, upon verifying the thread, the monitor times the execution of the thread, and the monitor verifies the execution time.

4. The method according to claim 3, wherein the execution is timed using a programmable interval timer, and wherein the execution time is verified unless the timer times out.

5. The method according to claim 4, wherein if the operating system pre-empts the thread, the monitor pauses the timer, and when the operating system continues the thread, the monitor resumes the timer.

6. The method according to claim 3, wherein prior to assigning the execution time to the node, a worst-case execution time of each transition from the block is assigned to the arc representing the respective transition, and the execution time assigned to the node at least equals the execution time of each transition.

7. The method according to claim 6, wherein the execution time is assigned to the arc using at least one of an analysis of the program, or a profile of the execution.

8. A machine-readable storage medium storing a computer program the computer program, when executed by a control unit, causing the control unit to perform:
annotating the program with calls to a monitor, each call by a thread indicating the thread;
scheduling the program and the monitor for execution by an operating system; and
upon receiving a call, causing the monitor to verify the thread via the operating system.

9. An apparatus adapted to:
annotate the program with calls to a monitor, each call by a thread indicating the thread;
schedule the program and the monitor for execution by an operating system; and
upon receiving a call, cause the monitor to verify the thread via the operating system.
